(19) United States
(12) Patent Application Publication
(10) Pub. No.: US 2006/0000036 A1
(43) Pub. Date: Jan. 5, 2006

(54) Toothbrush having a movable upstanding cleaning element

(75) Inventors: Eyal Eliav, New York, NY (US); Henry Goldfine, Edison, NJ (US); John J. Gatzemeyer, Hillsborough, NJ (US)

Correspondence Address: BANNER & WITCOFF, LTD., ATTORNEYS FOR RESERVE;CLIENT NO. 3, 1001 G STREET, N.W., 11TH FLOOR, WASHINGTON, DC, 20001-4597, US

(73) Assignee: Colgate-Palmolive Company, New York, NY (US)

(21) Appl. No.: 11/181,997

(22) Filed: Jul. 15, 2005

Related U.S. Application Data
(63) Continuation-in-part of application No. 10/260,584, filed on Sep. 27, 2002, now Pat. No. 6,966,093.

(51) Int. Cl. A61C 17/22

(52) U.S. Cl. 15/22.1; 15/28; 601/142

(57) ABSTRACT

A powered toothbrush is provided and includes a handle portion having a neck formed at one end and a head coupled to the neck. The head includes a base and a first carrier that is coupled to the head and that is operatively connected to a drive mechanism for moving the first carrier in a first direction. The first carrier has bristles, elastomeric cleaning members, or a combination thereof extending outwardly therefrom. The head also includes a second carrier that is movably coupled to the head and includes an upstanding elastomeric element disposed along an upper surface thereof. The first carrier and the second carrier may be operatively connected such that movement of one carrier imparts movement to the other carrier.

### CROSS-REFERENCE TO RELATED APPLICATIONS

This application is a continuation in part of co-pending U.S. patent application Ser. No. 10/260,584, filed Sep. 27, 2002, which is incorporated herein by reference.

### FIELD OF THE INVENTION

The present invention relates to powered toothbrushes, and more particularly, to a toothbrush having a head with two distinct moving sections that each provides oral health benefits to the user.

### BACKGROUND

Toothbrushes provide many oral hygiene benefits. For example, toothbrushes remove plaque and food debris to help avoid tooth decay and disease. They remove stained pellicle from the surface of each tooth to help whiten the teeth. Also, the bristles combined with the brushing motion massage the gingival tissue for stimulation and increased health of the tissue.

Powered toothbrushes have been available for some time. Powered toothbrushes have advantages over manual (non-powered) toothbrushes in that they impart movement to the bristles at much higher speeds than possible manually. They also may impart different types and directions of motion. These motions, generally in combination with manual movement of toothbrush by the user, provide superior cleaning than manual toothbrushes. Typically, powered toothbrushes are powered by disposable or rechargeable batteries that power an electric motor that in turn drives a toothbrush head.

Known powered toothbrushes include a brush head with a bristle carrier portion that rotates, oscillates or vibrates in some manner so as to clean the teeth. The bristles, which typically comprise bristle tufts, are generally uniform with one end fixed into the bristle carrier portion and the other end free to contact the surface of the teeth while brushing. The free ends of the various tufts present a surface envelope that is capable of some deformation when the bristles bend. When in contact with the surface to be brushed, the bristles may deform so that the surface envelope tends to conform to the complex surface of the teeth. Human teeth generally lie in a “C” shaped curve within the upper and lower jaw, and each row of teeth consequently has a convex outer curve and a concave inner curve. Individual teeth often have extremely complex surfaces, with areas that may be flat, concave, or convex. The more precise conformation between the bristles and the tooth surface, the more effective toothbrush may be in cleaning, whitening and/or stimulating.

Known powered toothbrushes typically arrange the bristles in a compact conical or cylindrical pattern on a generally circular, disk-shaped bristle carrier. The powered toothbrush heads are traditionally compact, generally oval in shape, and the heads are produced with a flat trimmed bristle pattern. Alternatively, other head shapes and bristle patterns are available.

One example of a powered toothbrush is depicted in U.S. Pat. No. 5,625,916 to McDougall, which is hereby incorporated by reference in its entirety. The toothbrush shown in McDougall has a disc-shaped bristle carrier. The bristle carrier, and thus the bristles, are driven in a vibrating or oscillating manner. This type of toothbrush is described herein with reference to FIGS. 1A-1C. A toothbrush 5 includes a handle portion 10 at a proximal end of toothbrush 5 and a head 11 at a distal end of toothbrush 5. Handle portion 10 has compartments for containing a powered motor 14 and batteries 15 and 16. Head 11 includes a generally circular bristle holder (carrier) 13. A rotatable shaft 12 extends from the motor 14 to head 11. A shaft coupling 17 may be located along the shaft 12 and configured to provide for the shaft 12 to be separated at a point between the motor 14 and head 11. This permits the shaft to be removed from toothbrush 5, e.g., for cleaning, servicing, or replacement.

Head 11 includes a post 18 that provides a rotational pivot axis for the bristle holder 13 containing bristle tufts 19. The distal end of the shaft 12 has a journal or offset 20 that is radially displaced from the longitudinal axis of the shaft 12, which may be integrally formed therewith. The bristle holder 13 has a slot 22 that receives the offset 20. The offset 20 and slot 22 are configured so as to be oriented toward the intersection of the shaft 12 axis and the longitudinal axis of the post 18. When the motor 14 rotates the shaft 12, the motion of the offset 20 defines a circle about the shaft 12 axis and drivingly engages slot 22 such that the bristle holder 13 vibrates or oscillates about the post 18 axis through a rotational angle A. The rotational angle A is defined by the displacement of the offset 20 from the shaft 12 axis relative to the diameter of the bristle holder 13.

Although powered toothbrushes such as those described immediately above provide advantages over manual toothbrushes, they are subject to various limitations. Providing a rotating or oscillating bristle holder (carrier) with a typical oblong or oval toothbrush head constrains the size of the moving bristle holder, and consequently the area of bristles available for teeth cleaning. Also, when the bristles are placed in contact with the teeth during brushing, there is less bristle contact with adjacent areas, such as the gums. Thus, while these compact bristle patterns provide for cleaning, there is minimal whitening and stimulation.

One attempt to overcome the limitations associated with a small powered bristle area is shown in U.S. Pat. No. 6,000,083 to Blaustein et al. The toothbrush in Blaustein et al. has a bristle area and pattern similar to a manual toothbrush, but an area of the bristles has simply been replaced by a powered bristle section. The result is that head has a powered or moving bristle section and a static bristle section. The limitation of Blaustein et al. is that the static bristle section provides no better cleaning, whitening or stimulation than a manual toothbrush.

International Application No. PCT/EP01/07615 of Braun GmbH discloses a powered toothbrush with two separate bristle parts that can move. Each bristle part can have a different range and/or type of motion. However, only one bristle part is powered. The other unpowered bristle part moves due to a resonance effect imparted by the frequency of the movement of the first bristle part.

This free resonance causes a number of difficulties. First, because any contact between the bristle parts will dampen or cancel any resonance of the unpowered bristle part, the unpowered bristle part “floats” separately from the powered bristle part. This necessitates separation or gaps between them. These gaps expose the internal workings of the head to foreign matter such as water, saliva, toothpaste, and food particles. This foreign matter may interfere with the workings of the unpowered bristle head. For example, the unpowered bristle part is spring-loaded to assist its resonance. Foreign matter may accumulate on or around the spring, interfering with its function. In addition, food particles may remain in the head and may fester and host microorganisms, which are undesirable if not potentially harmful when introduced directly into the mouth.

Another limitation of such a design is that movement of the unpowered bristle part may be damped by contact with the teeth, or lessened when the frequency of the powered part shifts from the resonance frequency. This can occur due to pressure imparted against the powered bristle part by the teeth or gums during brushing. Finally, the energy imparted to the unpowered bristle part is only a portion of the energy input into the powered part. Therefore, the unpowered bristle part is less effective in cleaning than the powered part, limiting the overall effectiveness of toothbrush.

Thus, there is a need in the art for a powered toothbrush with increased effectiveness through a larger area of powered or driven bristles or bristles that are otherwise movable. There is also a need for a toothbrush having increased whitening and/or stimulation than known toothbrushes. There is further a need for such improved toothbrushes to be comparable in manufacturing and purchasing costs as known powered toothbrushes.

### SUMMARY

A powered toothbrush is provided that includes a handle portion at a proximal end and either a fixed head or a linkage for receiving a removable head at a distal end thereof. A neck is further formed between the handle portion and the head. According to one embodiment of the invention, the head includes two movable parts that each and together provide oral health benefits. The movable parts are adapted to have a number of bristles and/or elastomeric cleaning members extending therefrom for contacting oral features such as one or more teeth and surrounding areas. The powered toothbrush is further formed with a drive mechanism that imparts movement to the first movable part to deliver one or more beneficial actions such as cleaning, polishing, and/or whitening actions that supplement the cleaning efficiency of the toothbrush. The second movable part may also be movable to deliver further beneficial actions and/or to enhance the benefits provided by the first movable part. In addition, the first movable part may impart movement to the second movable part or the second movable part may be independently driven.

In one embodiment, the first movable head part is a first bristle carrier that supports a number of bristle tufts, elastomeric cleaning members, or a combination thereof. The first bristle carrier is operatively mounted to the head and is coupled to the drive mechanism such that the first bristle carrier oscillates back and forth in a direction parallel to the toothbrush head. Preferably, the oscillating first bristle carrier is moved back and forth in a rotational direction. The second movable part is in the form of a second carrier that is coupled to the head and includes an upstanding elastomeric element disposed along an upper surface thereof.

Other features and advantages of the present invention will be apparent from the foregoing detailed description when read in conjunction with the accompanying drawings.

### BRIEF DESCRIPTION OF THE DRAWINGS

FIG. 1A is a front partial cross-sectional view of a conventional powered toothbrush including a head.

FIG. 1B is a partial side cross-sectional view of the toothbrush head of FIG. 1A.

FIG. 1C is a partial front cross-sectional view of the toothbrush head of FIG. 1A.

FIG. 2 is a perspective view of a powered toothbrush according to one embodiment of the invention showing a toothbrush head having distinct first and second movable sections constructed in accordance with the invention.

FIG. 3 is a perspective view of a powered toothbrush head according to another embodiment constructed in accordance with the invention.

FIG. 4 is a perspective exploded view of the powered toothbrush head of FIG. 3.

FIGS. 5A-5C are front views of the powered toothbrush head of FIG. 3 in various positions generated when in motion.

FIG. 6 is a perspective view of another embodiment of a powered toothbrush head of the powered toothbrush of FIG. 2.

FIG. 7 is a perspective exploded view of the powered toothbrush head of the powered toothbrush of FIG. 6.

FIGS. 8A-8B are front views of the powered toothbrush head of FIG. 6 in various positions generated when in motion.

FIG. 9 is a perspective view of another embodiment of the powered toothbrush head of the powered toothbrush of FIG. 2.

FIG. 10 is a perspective view of another embodiment of the powered toothbrush head of the powered toothbrush of FIG. 2.

FIG. 11 is a perspective exploded cut-away view of the powered toothbrush head of the powered toothbrush of FIG. 10.

FIG. 12 is a perspective view of another embodiment of the powered toothbrush head of the powered toothbrush of FIG. 2.

FIG. 13 is a perspective view of another embodiment of the powered toothbrush head of the powered toothbrush of FIG. 2.

FIG. 14 is a perspective view of another embodiment of the powered toothbrush head of the powered toothbrush of FIG. 2.

FIG. 15A is a perspective view of an elastomeric tooth care element having a first configuration and adapted for use in a toothbrush head constructed in accordance with the invention.

FIG. 15B is a perspective view of an elastomeric tooth care element having a second configuration and adapted for use in a toothbrush head constructed in accordance with the invention.

FIG. 15C is a perspective view of an elastomeric tooth care element having a third configuration and adapted for use in a toothbrush head constructed in accordance with the invention.

FIG. 15D is a perspective view of an elastomeric tooth care element having a fourth configuration and adapted for use in a toothbrush head constructed in accordance with the invention.

FIG. 15E is a perspective view of an elastomeric tooth care element having a fifth configuration and adapted for use in a toothbrush head constructed in accordance with the invention.

FIG. 16 is a perspective view of another embodiment of the powered toothbrush head of the powered toothbrush of FIG. 2.

FIG. 17 is a front view of the powered toothbrush head of FIG. 16.

FIG. 18 is a rear view of the powered toothbrush head of FIG. 16.

FIG. 19 is a side view of the powered toothbrush head of FIG. 16.

FIG. 20 is front view of an upstanding elastomeric wall of FIG. 16.

FIG. 21 is a perspective view of another embodiment of the powered toothbrush head of the powered toothbrush of FIG. 2.

FIG. 22 is a front view of the powered toothbrush head of FIG. 21.

### DETAILED DESCRIPTION OF THE DRAWINGS

The invention will be described in the general context of a powered toothbrush and head portions of a powered toothbrush. However, those skilled in the art will appreciate that the invention may be practiced with other oral care implements and devices, including tongue-cleanser devices, professional dental equipment, and the like. In addition, aspects and features of the powered toothbrushes and head portions described herein may be practiced in various combinations forming a variety of embodiments of the invention.

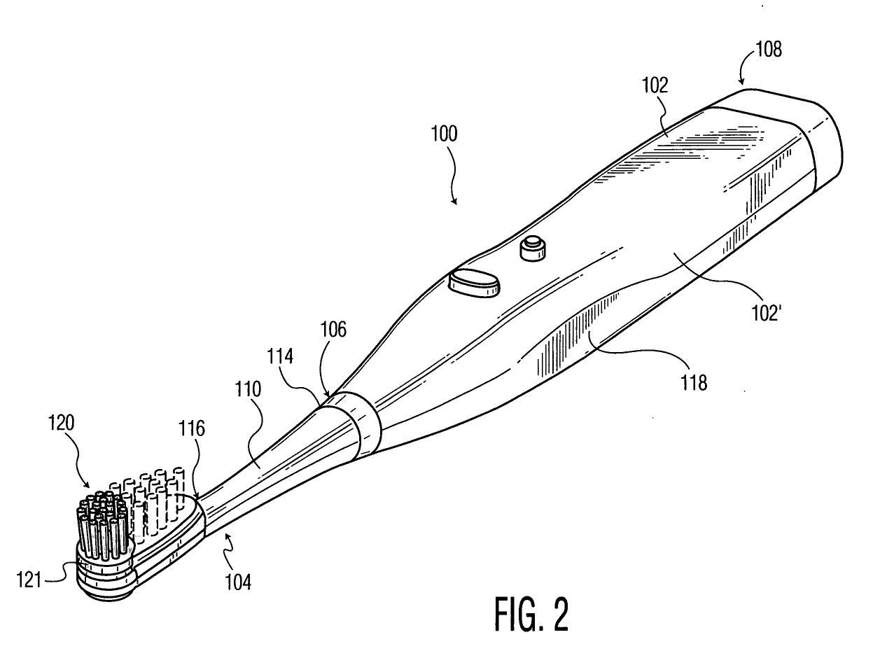

Referring first to FIG. 2, a powered toothbrush according to a first embodiment of the invention is illustrated and generally indicated at 100. Toothbrush 100 includes a handle 102 at a proximal end thereof that defines an interior compartment (not illustrated) for housing various toothbrush components, and a brush section 104 that is defined by a neck 110 that terminates in a head 120 at a distal end of toothbrush 100. Handle 102 has a free proximal end 108 and an opposite neck end 106. Neck 110 generally includes a first end 1114 and a second end 116 with first end 114 being located at neck end 106 of handle 102 and the second end 116 being located at head 120. In other words, neck 110 is the portion of toothbrush 100 that extends between handle 102 and head 120. Neck 110 also defines an interior compartment (not shown) for housing various working components of toothbrush 100. Head 120 is preferably generally aligned with the longitudinal axis of toothbrush 100.

Neck 110 and handle 102 may be constructed as a unitary member by forming neck 110 integral to handle 102 at neck end 106 of handle 102, or may be formed detachable from handle 102 at neck end 106 of neck 110. In accordance with this detachable embodiment, the combined neck 110 and head 120 can be removed from handle 102 to permit cleaning, servicing and/or interchanging of either handle 102 or the combined neck 110 and head 120 (brush section 104). When neck 110 is formed to be detachable from handle 102, first neck end 114 preferably includes a connector linkage (not illustrated) that is adapted to be detachably joined to handle 102 using traditional techniques. It will also be appreciated that the point of detachment may be between head 120 and neck 110 such that head 120 is of a refill head type. Furthermore, head 120 is formed of a first bristle carrier 121 and a second bristle carrier 122.

It will further be appreciated that the illustrated shapes of handle 102 and neck 110 are merely exemplary in nature and handle 102 and/or neck 110 can be formed to have any number of shapes. Preferably, the shapes of handle 102 and neck 110 are ergonomically pleasing to a user of toothbrush 100 and provide a toothbrush that is easily gripped and held and easily manipulated by the user. For example, handle 102 may include slightly recessed finger sections 118 which are formed on opposite sides of handle 102. One recessed finger section 118 is designed to receive the thumb of one hand and the other recessed finger section 118 is designed to receive one or more other fingers of the same hand to thereby assist the user in proper placement of toothbrush 100 in the user's hand. One or more of recessed finger sections 118 may include ribs or another type of roughened surface to assist the user in gripping toothbrush 100 at recessed finger sections 118.

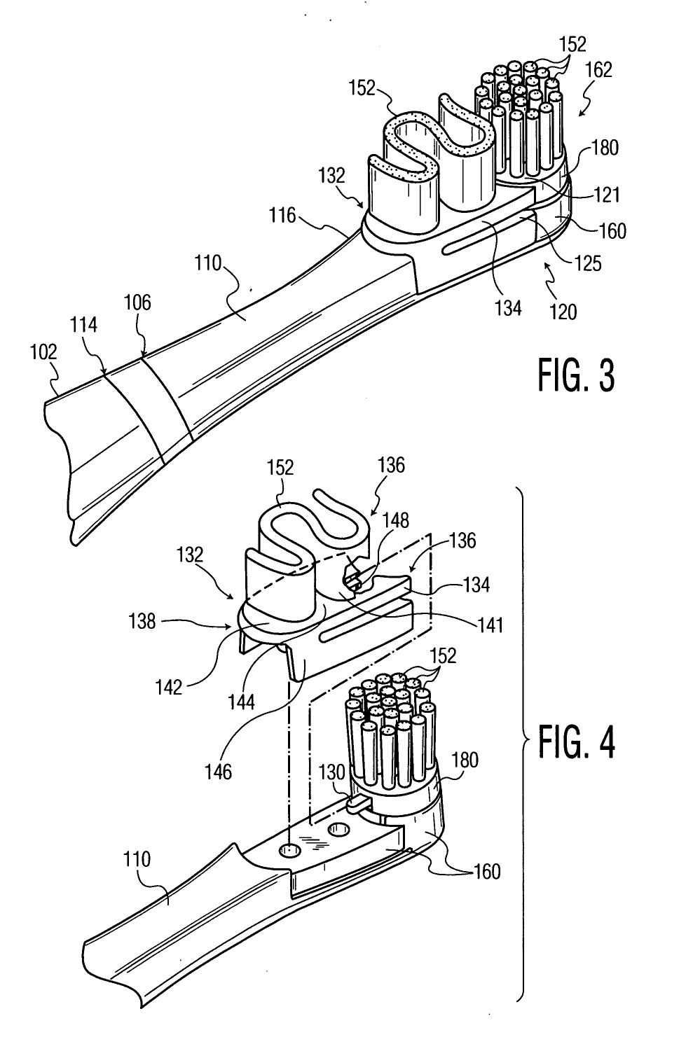

Referring next to FIGS. 3 and 4, an additional embodiment of a powered toothbrush head is shown. A head 120 of toothbrush 100 includes a head base 160 that partially defines an inner compartment 125 of head 120. Head base 160 may be constructed so that it terminates in a rounded distal end 162, which also defines the distal end of toothbrush 100. Preferably, head base 160 is integrally attached to second end 116 of neck 110.

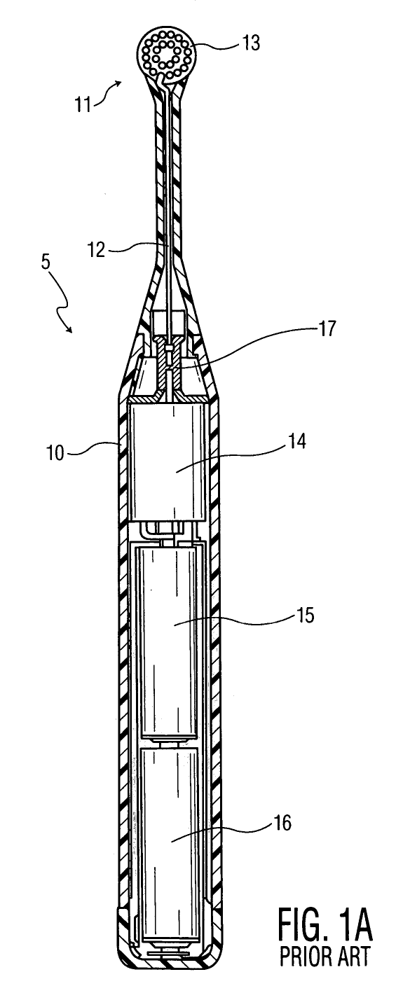

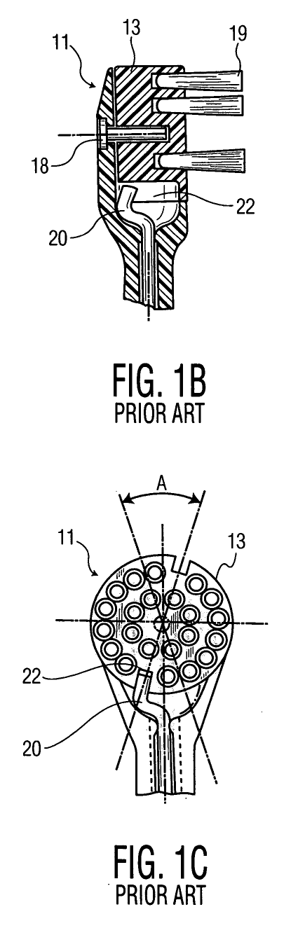

Head 140 also includes a first movable bristle carrier 180 which is illustrated as being at the outermost or distal portion of head 140. First bristle carrier 180 may have a construction that is either identical to or similar to that of the bristle holders 13 or 121 illustrated in FIGS. 1A-1C and FIG. 2. First movable bristle carrier 180 is preferably formed with a disk having circular cross-section since it is intended to oscillate in a rotational manner about a center point thereof. First movable bristle carrier 180 is formed with a protrusion 130 directed toward a second movable bristle carrier 132. However, it will be appreciated that first movable bristle carrier 180 is not limited to having a disk shape and can have any number of different shapes, such as an oval or various other regular or irregular shapes, so long as first moveable bristle carrier 180 is able to oscillate in a substantially rotational manner. A circular shape may be preferred since it requires the least amount of clearance to accommodate the oscillating movement.

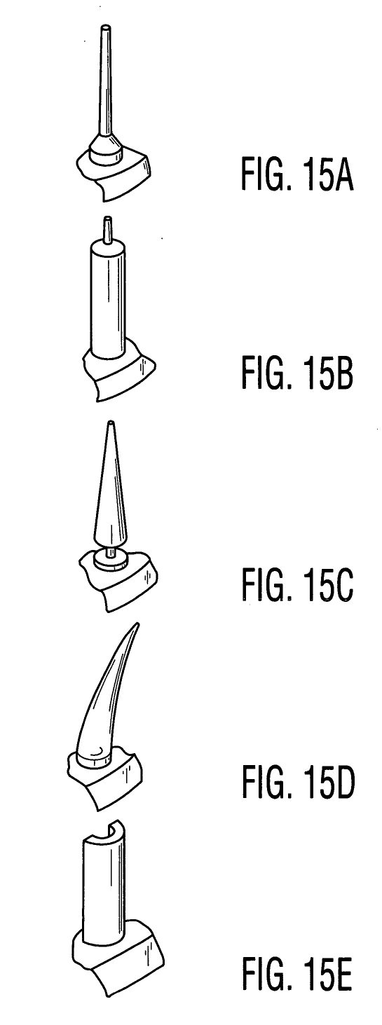

A plurality of tooth care elements 152 are coupled to and extend outwardly from first movable bristle carrier 180 in a direction substantially perpendicular to a plane defined by a face of first movable bristle carrier 180. As used herein, the term “tooth care elements” includes any type of structure that is commonly used or is suitable for use in providing oral health benefits (e.g., tooth cleaning, tooth polishing, tooth whitening, etc.) by making intimate contact with surfaces of the teeth and surrounding areas. Such tooth care elements include but are not limited to tufts of bristles that can be formed to have a number of different shapes and sizes, and various elastomeric members (see FIGS. 15A-15E) that can be formed to have a number of different shapes and sizes, or a combination of both. Bristle tufts arranged on first bristle carrier 180 is only one configuration and it will be understood that other bristle configurations (such as stapled, IMT, etc.) can be used. Bristle tufts may all be formed of the same or different bristle materials (such as nylon bristles, spiral bristles, rubber bristles, etc.) Moreover, while the tooth care elements can be arranged so that they are generally perpendicular to the face of first bristle carrier 180 (as noted above), some or all of the tooth care elements can be angled at various angles with respect to first bristle carrier 180 as desired. When first bristle carrier 180 includes bristle tufts, it is thereby possible to select the combination of bristles configurations, bristle lengths, bristle materials and bristle orientations to achieve specific intended results, such as to create as much movement from the moving tuft heads to deliver additional oral health benefits such as enhanced cleaning, tooth polishing and/or tooth whitening.

While first bristle carrier 180 has been defined as a movable bristle carrier 180, it will be understood that first movable carrier 180 is not limited to having only tufts of bristles as a part thereof. Instead, first movable carrier 180 is to be broadly considered as being a carrier for any number of suitable tooth care elements 152 or any number of combinations of different types of tooth care elements 152. For example, first movable carrier 180 may include a number of elastomeric members to provide the desired oral health benefits. The elastomeric members may be attached to first movable carrier 180 using conventional techniques, including integrally forming the elastomeric members with an upper surface of carrier 180. Tooth care elements 152 provided as part of first movable carrier 180 can thus be entirely of one type (e.g., bristle tufts or elastomeric members) or can be formed according to a mixed arrangement.

FIGS. 15A-15E illustrate various elastomeric members that can serve as tooth care elements 152. FIG. 15A shows an elastomeric tooth care element in the form of a thin spike; FIG. 15B shows an elastomeric tooth care element in the form of a barrel spike; FIG. 15C shows an elastomeric tooth care element in the form of a squeegee point; FIG. 15D shows an elastomeric tooth care element in the form of an angled point; and FIG. 15E shows an elastomeric tooth care element in the form of a section of an elastomeric wall. The elastomeric wall of FIG. 15E can have a linear, planar shape; a zigzag shape; a serpentine shape, etc. All of the above elastomeric tooth care elements can have smooth textures or can have rough surfaces. In addition, the wall sections of the elastomeric tooth care elements can be vertically straight, taper toward inward toward one end or expand toward one end. The tops of the elastomeric tooth care walls can have a planar surface or can have a protrusion (i.e., hump) or the like formed thereat.

Referring again to FIGS. 3 and 4, for purpose of illustration only, first movable carrier 180 will be described as containing a predetermined number of bristle tufts; however, the following features apply equally to the situation where first movable carrier 180 is formed entirely or partly of elastomeric members. The bristle tufts of first movable carrier 180 may be formed with uniform heights or non-uniform heights. For example, first movable carrier 180 may include bristle tufts having a first height as well as bristle tufts having a second different height.

First movable bristle carrier 180 is constructed so as to pivotally rotate about a center point thereof, thereby effectuating movement of the bristle tufts and/or elastomeric members that extend outwardly from first movable bristle carrier 180. The movement of first movable bristle carrier 180 is preferably an oscillation type movement as first movable bristle carrier 180 pivots about a post at a center point thereof (see FIG. 1). First movable bristle carrier 180 is formed with a slot or opening (not illustrated). This slot is preferably identical to or substantially similar to slot 22 illustrated in FIGS. 1A-1C. Preferably, slot 22 is formed at a peripheral edge of first movable bristle carrier 180 and extends along a substantial height of first movable bristle carrier 180. For example, slot 22 preferably does not extend to the upper surface of first bristle carrier 180 where the tooth care elements are positioned. Instead, slot 22 preferably has a closed upper end to prevent foreign matter, such as saliva, toothpaste, foreign particles, etc., from entering slot when the operator is performing a brushing operation. The opposite end of slot 22 that is located within the inner compartment 125 of head 140 can be open.

Toothbrush 100 includes a drive mechanism to effectuate movement of certain parts of the toothbrush, and more specifically, for causing movement of first movable bristle carrier 180. One drive mechanism is disclosed in U.S. Pat. No. 5,625,916 to McDougall, which has been previously incorporated herein by reference and includes a rotating drive shaft 240 (FIG. 11) that extends at least through neck 110 (i.e., the inner compartment thereof). Drive shaft 240 preferably has a construction that is the same as or similar in nature to shaft 12 illustrated in FIGS. 1A-1C.

Drive shaft 240 has one end (not illustrated) that is operatively connected to a drive member (not illustrated), such as a motor or any other type of drive device, for imparting movement to first movable bristle carrier 180. Drive shaft 240 is formed with an opposing distal end (not illustrated) that is bent such that the end is not axially aligned with the longitudinal axis of drive shaft 240. This distal end may be formed similar to the end 20 of FIGS. 1A-1C or may be formed differently so long as it performs the intended function. In other words, the end is an offset crank end of drive shaft 240 and is configured to be received in slot 22 so that a 360 degree rotational movement of shaft 240 is transmitted into an oscillating back and forth rotational movement of first movable bristle carrier 180.

The drive mechanism for powered toothbrush 100 can be any type of drive, e.g., a rotating drive, an oscillating drive, an eccentric drive, an unbalanced-generated drive, a drive having one more gearing mechanisms, and/or the like, that is capable of performing the intended function. The drive mechanism can be realized in the form of an electric motor or other type of motor and the movement generated by the drive can be imparted to one or more sections of head 140 (or 120) or to other elements that can be present at the brush section, such as bristle tufts, elastomeric members. The movement can be imparted directly through a driving axle, such as drive shaft 240 or it can be imparted through a driving post attached to the driving axle. When toothbrush 100 includes an oscillating drive mechanism either identical to or similar to the drive mechanism illustrated in FIGS. 1A through 1C, the interior compartment of handle 102 houses a motor operatively connected to drive shaft 200 and a source to power the motor, such as one or more batteries.

When the drive mechanism is actuated and drive shaft 240 is rotated, the movement of the crank end thereof imparts an oscillating back and forth movement of first movable bristle carrier 180 through an angle between about 10 degrees to about 120 degrees and in a preferred embodiment, the movement is through an angle between about 10 degrees to about 30 degrees, and in a more preferred embodiment is through an angle between about 10 degrees to about 15 degrees.

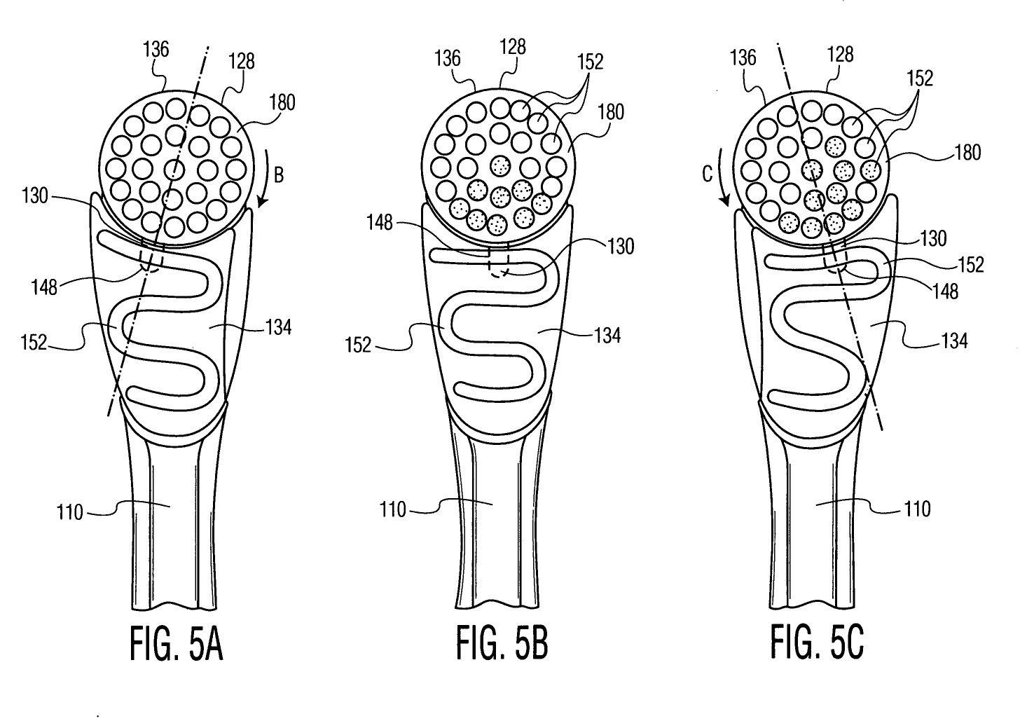

As shown in FIGS. 3 and 4, the toothbrush 100 further includes a second movable bristle carrier 132 that is operatively mounted on the head 120. The second movable bristle carrier 132 comprises a platform 134 having a first end 136, a second end 138, a first end midpoint 141, a second end midpoint 142, a midpoint 144, and a bottom 146. The platform 134 defines a recess 148 that is preferably defined at the first end 136 and protrusion 130 of first movable bristle carrier 121 (128 not introduced until FIG. 5) is received into recess 148. The movement of first movable bristle carrier 121 directly imparts movement to platform 134.

There are numerous configurations of the present invention that can change the type and range of motion of both first movable bristle carrier 121 and second movable bristle carrier 132. The movement of first movable bristle carrier 121 is outlined in the example configuration above can be altered by varying the transmission of motion from the drive mechanism to first movable bristle carrier 121. In addition, changes in second movable bristle carrier 132 can vary the movement of the first bristle carrier as well. Various embodiments may be designed so that protrusion 130 of the first movable bristle carrier 121 is rigidly received in the recess 148, or protrusion 130 may be frictionally received in recess 148.

In the embodiment of FIGS. 3 and 4, tooth care element 152 is an elastomeric tooth care element formed of an elastomeric wall, which can have a linear, planar, zigzag or serpentine shape. Tooth care element 152 may travel from second end 138 to first end 136 of the platform 134.

FIGS. 5A-5C illustrate another embodiment in which second movable bristle carrier 132 is attached to platform 134 and first carrier 180 via protrusion 130 and recess 148. FIGS. 5A and 5C illustrate first end 136 of first movable bristle carrier 128 oscillating in a clockwise motion B and counterclockwise motion C, respectively. The clockwise motion B and counterclockwise motion C forces protrusion 130 to engage recess 148 and cause platform 134 to move in a direction both parallel and perpendicular to first end 136. This clockwise motion B and counterclockwise motions C may also cause tooth care element 152 to stretch or compress and/or to slidingly translate on top of platform 134. FIG. 5B illustrates first movable bristle carrier 128 and platform 134 at rest.

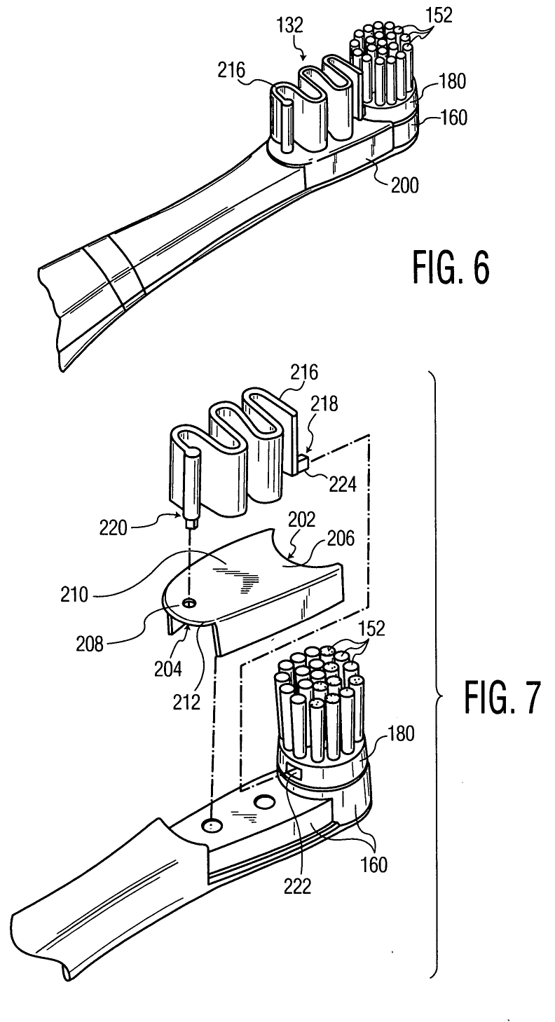

Referring next to FIGS. 6 through 9, another head embodiment is illustrated. The handle 102, neck 110, drive, and head base 160 may be the same as described above. However, first movable bristle carrier 180 defines one or more recesses 222 directed toward second movable bristle carrier 132. Second movable bristle carrier 132 includes a carrier base 200 having a first end 202, a second end 204, a first end midpoint 206, second end midpoint 208, a midpoint 210, and a bottom 212. Additionally, a continuous elastomeric polishing element 216 is formed with a carrier end 218 and a far end 220. Continuous elastomeric polishing element 216 is attached to first movable bristle carrier 180 at carrier end 218 via a protrusion 224 engaging recess 222, and is attached to carrier base 200 at far end 220. In the displayed embodiment, far end 220 passes through a hole in base 204, and directly engages base 160. The movement of first movable bristle carrier 180 directly imparts movement to continuous elastomeric polishing element 216 via the interaction of recess 222 and protrusion 224, which may include sliding, translational movement of polishing element 216 along the face of carrier base 200 in a direction parallel to the carrier face.

Continuous elastomeric polishing element 216 may include a plurality of elastomeric contact elements linked continuously together. In a preferred embodiment, the continuous elastomeric polishing element 216 is formed as a wall. Regardless of the elastomeric contact elements that comprise the continuous elastomeric polishing element 216, the continuous elastomeric polishing element 216 may traverse certain fixed paths. The continuous elastomeric polishing element 216 may traverse a straight path, zigzag path or a serpentine path between the carrier end 218 and the fixed end 220.

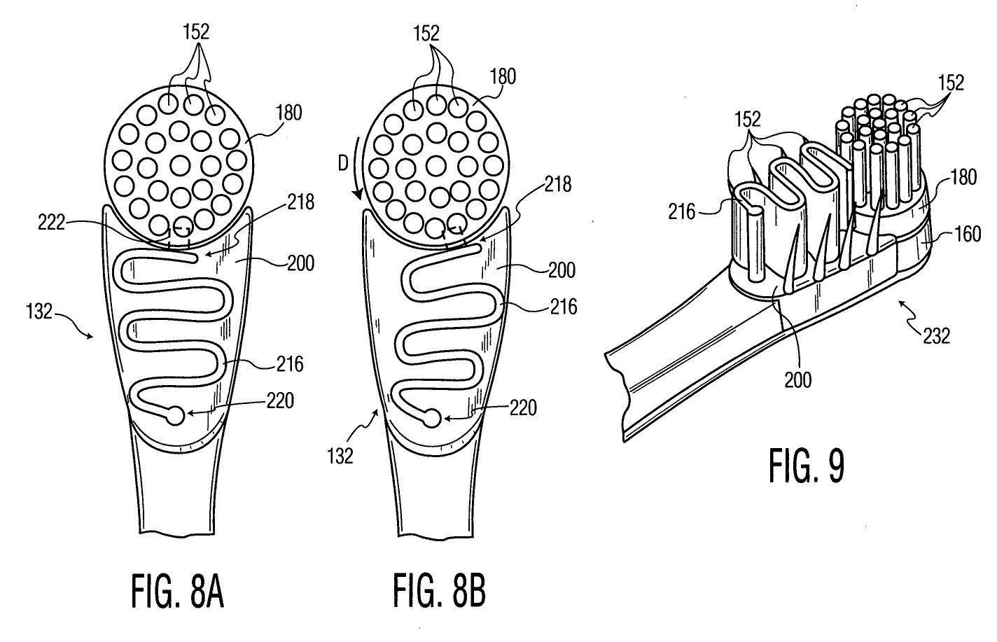

FIGS. 8A and 8B illustrate the embodiment of FIGS. 6 and 7 while in motion. FIG. 8A illustrates first movable bristle carrier 180 at rest. FIG. 8B illustrates first movable bristle carrier 180 oscillating in a counterclockwise motion D. The counterclockwise motion D of first movable bristle carrier 180 causes the continuous elastomeric polishing element 216 to elongate and translate in a direction parallel to the movement of carrier end 218. Thus, while motion has been shown in the counterclockwise direction, it will be understood that first movable bristle carrier 180 can oscillate in the clockwise direction, thus compressing the continuous elastomeric polishing element 216 as well as translating it in a direction parallel to the movement of carrier end 218. It is also illustrated, as noted above, that the continuous elastomeric polishing element 216 is attached to the first movable bristle carrier 180 by way of protrusion 224 entering recess 222. It will be well understood that the continuous elastomeric polishing element 216 can be connected to the first movable bristle carrier 180 in numerous ways known in the art.

Referring additionally to FIG. 9, second movable bristle carrier 132 may further include a plurality of tooth contact elements 152 attached to carrier base 200.

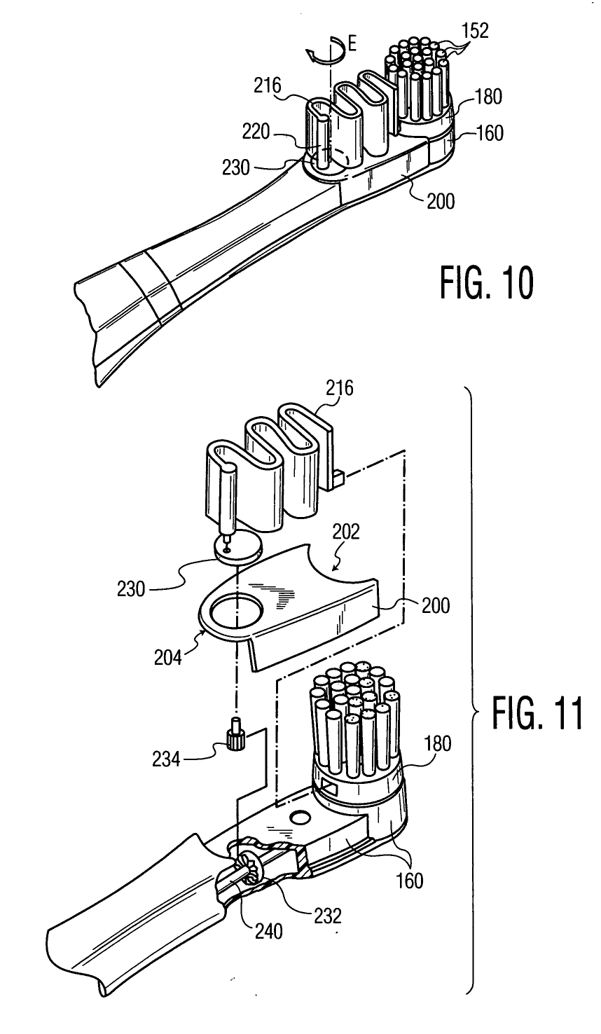

Referring next to FIGS. 10 through 14, another embodiment constructed in accordance with the invention is shown. This embodiment is similar to the previous embodiment with the exception that this embodiment contains an additional feature. The powered toothbrush now includes a third movable bristle carrier 230 drivingly engaged to the drive mechanism to enable movement of continuous elastomeric polishing element 216. Continuous elastomeric polishing element 216 is attached to third movable bristle carrier 230 at far end 220 of the continuous elastomeric polishing element. Third movable bristle carrier 230 may be formed as a disk of circular cross-section since it is intended to oscillate in a rotational manner. However, it will be appreciated that the third movable bristle carrier 230 is not limited to having a disk shape and can have any number of different shapes, such as an oval or various other regular or irregular shapes, so long as the third movable bristle carrier 230 can oscillate in a rotational manner, vibrate, translate or move in a combination thereof. A circular shape may be preferred since it requires the least amount of clearance to accommodate the oscillating movement. The rotational movement of third movable bristle carrier 230 may include rotation through an angle of about 360 degrees (arrow E). The vibrational movement of the third movable bristle carrier 230 can include vibration perpendicular to the axis of head 120. The translation movement may be a translation from about first movable bristle carrier 180 to about second end 204 of carrier base 200. The lateral movement of the third movable bristle carrier 230 may be a movement parallel to second end 204 of carrier base 200.

As with the other embodiments, continuous elastomeric polishing element 216 may traverse certain fixed paths in this embodiment. Continuous elastomeric polishing element 216 may traverse a straight path, zigzag path or a serpentine path between carrier end 218 and fixed end 220.

FIG. 11 illustrates a sample gearing system to drive third movable bristle carrier 230. A main gear 232 is fixed to drive shaft 240 and meshingly engaged to a minor gear 234. Minor gear 234 is operatively connected to third movable bristle carrier 230 and imparts a driving movement from drive shaft 240 thereto. However, it will be appreciated that third movable bristle carrier 230 is not limited to the gearing system illustrated above, third movable bristle carrier 230 can be driven from a drive shaft 240 any number of ways so long as the third movable bristle carrier 230 is driven.

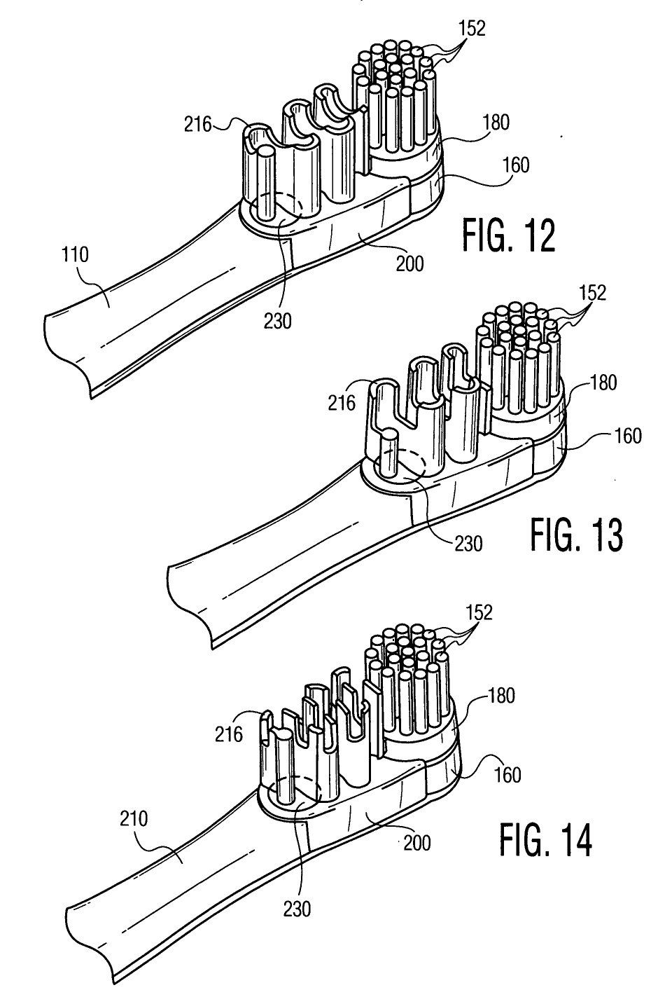

FIGS. 12 through 14 illustrate additional embodiments of continuous elastomeric polishing element 216. The continuous elastomeric polishing element 216 may have a hump, a large set of projections or a smaller set of projections.

A powered toothbrush made in accordance with any of the present embodiments offers a number of advantages over conventional powered toothbrushes that are presently available. First movable bristle carrier 180 oscillates back and forth, or moves otherwise. As the operator brushes his or her teeth, the oscillating tooth care elements (i.e., bristle tufts and/or elastomeric members) contact the surfaces of the teeth and the surrounding areas to deliver enhanced cleaning, tooth polishing and/or tooth whitening. The elastomeric second bristle carrier 132 permits a number of additional tooth care elements to be disposed in a number of different patterns. The increased number of moving tooth care elements of second bristle carrier provides increased contact with gingival tissues and enhanced massaging thereof.

The toothbrush according to the various embodiments disclosed herein can be made from any number of materials that are suitable for use in oral care products, such as toothbrushes, etc. For example, many of the components that are included in toothbrush are formed of plastic materials. Accordingly, the handle and head of the powered toothbrush may be molded from polyolefins such as polypropylenes and polyethylenes, polyamides such as nylons, and polyesters such as polyethylene terephthalate. Other suitable materials include polymethylmethacrylate, styrene acroylonitrate and cellulose esters, for example cellulose propionate.

When the tooth care elements are in the form of tufts of bristles, the bristles of can be made from a flexible material suitable for dental hygiene. Generally, materials suitable for bristles are polyamides such as nylon or polyesters such as polybutylene terephthalate. When the tooth care elements are in the form of elastomeric members, they can be made from any number of suitable elastomeric materials, such as a block copolymer. Preferred block copolymers include styrenes (for example styrene ethylene butadiene styrene, or styrene butadiene styrene), polyolefins (for example polypropylene/ethylene propylene diamine modified systems (i.e. synthetic rubber)), polyamides (for example polyamide (2 or polyamide 6), polyesters (for example polyester ester or polyether ester); polyurethanes (for, example polyesterurethane, polyetherurethane or polyesteretherurethane).

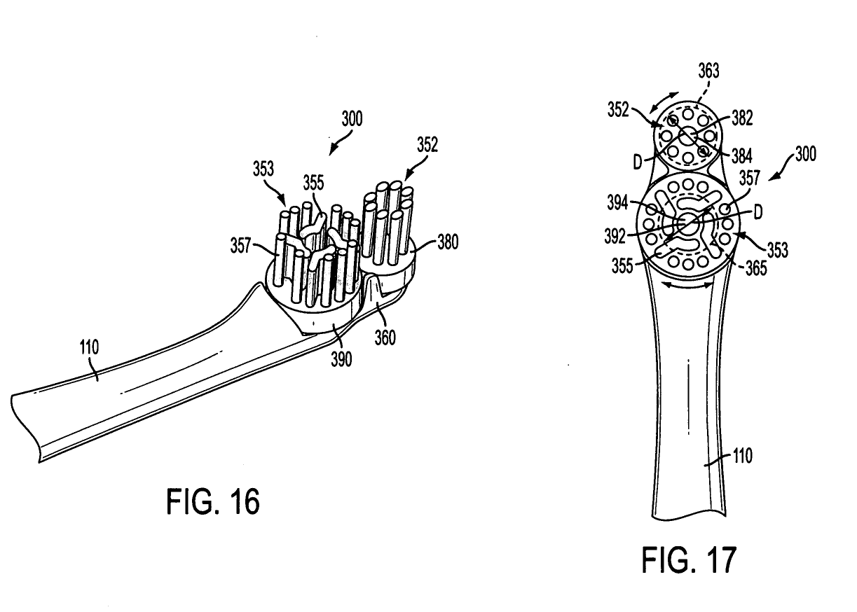

Referring now to FIGS. 16-20, a toothbrush head 300 is shown according to an embodiment of the invention that can be used with handle 102 and neck 106 of toothbrush 100. Toothbrush head 300 generally includes the aspects and features and toothbrush 100, except as discussed hereafter. As shown, toothbrush head 300 includes a head base 360 that is integrally attached to neck 110, a first movable carrier 380 at a distal portion of head 300 that is attached to the head base, and a second movable carrier 390 attached to the head base and disposed between the first movable carrier and the neck.

First and second movable carriers 380 and 390 may be formed with disks having circular cross-section to permit oscillation in a rotational manner about center points 382 and 392 respectively thereof. However, it will be appreciated that the movable carriers are not limited to having a disk shape and can have any number of different shapes, such as an oval or various other regular or irregular shapes, and can different shapes from each other. A circular shape may be preferred since it requires the least amount of clearance to accommodate oscillating movement.

A plurality of tooth care elements 352 are coupled to and extend outwardly from first movable carrier 380 in a direction substantially perpendicular to a plane defined by a face of first movable carrier 380. In the configuration shown in FIGS. 16-20, tooth care elements 352 include tufts of bristles. However, other types of cleaning elements in various combinations may be used to provide a variety of cleaning, tooth polishing, tooth whitening or other types of oral care benefits, such as rubber elements, elastomeric elements, polishing elements, abrasive elements, floss-like cleaning elements, upstanding elastomeric wall regions etc.

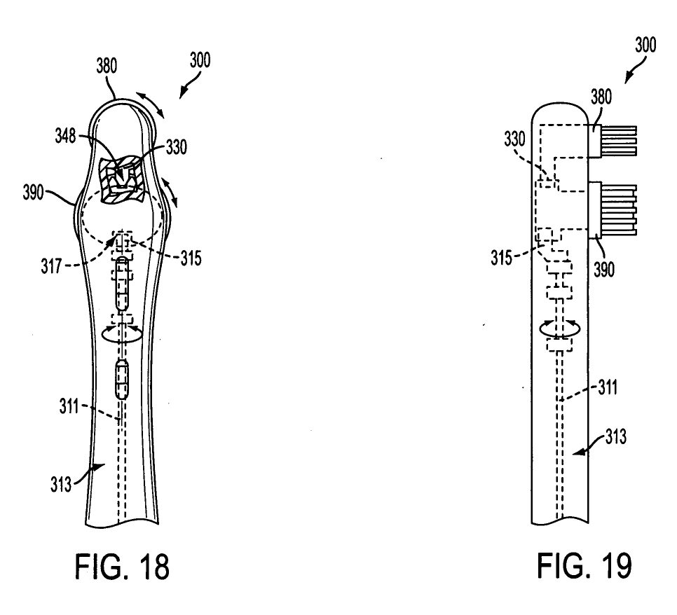

First movable carrier 380 is constructed so as to pivotally rotate about center point 382 thereof, thereby effectuating movement of the tooth care elements that extend outwardly from first movable carrier 380. The movement of first movable carrier 380 is preferably an oscillation type movement as first movable carrier 380 pivots about a post 384 at center point 382. As shown in FIG. 18, first movable carrier 380 is formed with a projection 330 for engaging second movable carrier 390. In an alternative configuration, carrier 380 may include a slot (not shown) for receiving a projection from second carrier 390. Projection 330 is formed at a peripheral edge of first movable carrier 380 at a lower portion of the carrier, which may be retained within head base 360 to avoid contact with foreign matter or oral features.

Similar to the first movable carrier, second movable carrier 390 is constructed so as to pivotally rotate about center point 392 thereof, thereby effectuating movement of the bristle tufts and/or elastomeric members that extend outwardly therefrom. The movement of second movable carrier 390 is preferably an oscillation type movement as second movable carrier 390 pivots about a post 394 at its center point 392. As shown in FIG. 18, second movable carrier 390 is formed with a slot 348 for receiving projection 330 of first movable carrier 380. In an alternative configuration, carrier 390 may include a projection for engaging a slot or recess of the first carrier. Slot 348 is formed at a peripheral edge of second movable carrier 390 at a lower portion of the carrier at the same level as projection 330 and may also be retained within head base 360 to avoid contact with foreign matter or oral tissue.

As shown in FIGS. 18 and 19, a drive shaft 311 of a drive mechanism 313 operatively engages second carrier 390 to cause it to rotate about its pivot point 392. A distal end of shaft 311 includes an offset 315 that is radially displaced from the longitudinal axis of the shaft, which is received into a recess 317 of the second carrier. When a motor of the drive mechanism rotates the shaft back and forth in an oscillating manner, the offset drives the second carrier to rotationally oscillate about it pivot point 392. Similarly, rotation of the second carrier causes the first carrier to rotate about its pivot point 382 via slot 348 and projection 330. Thus, in operation, second carrier 390 acts as a driver that drives first carrier 380. In alternative configurations (not shown), the first carrier 380 may drive the second carrier 390, or the first and second carriers may be independently driven and may be independently movable. In other alternative configurations, the first and second carriers may rotate rather than oscillate, or may move in other directions, such as translating in or more directions.

In the driver/driven configuration shown in FIGS. 18 and 19, the first and second carriers counter-oscillate or rotate in opposite directions. For example, when second carrier 390 is rotating in a clockwise direction about its pivot point, it drives first carrier 380 to rotate in a counterclockwise direction. Such counter-rotation of the carriers can be beneficial for reducing or eliminating any net torque to the overall toothbrush during operation, as well as for providing enhanced cleaning and polishing benefits. It is understood, however, that first and second carriers may be movable in various ways and in a variety of directions with respect to each other. For instance, the carriers may translate with respect to each other during operation of the toothbrush and may be independently movable with respect to each other.

As shown in FIG. 17, first movable carrier 380 includes a plurality of cleaning elements 352 in the form of bristles that are arranged in a generally circular configuration within a circular region 363 having a diameter D. Second movable carrier 390 may be larger than first movable carrier 380 and includes a plurality of cleaning elements 353, which include cleaning elements 355 at least partially disposed within an inner circular region 365 that may also have a diameter D. In the configuration of FIG. 17, cleaning elements 353 are upstanding elastomeric wall portions disposed within the inner region of the second carrier, which can provide cleaning and polishing benefits to the user's teeth. As such, during forward motion of toothbrush 300, a first type of cleaning elements 352 on the first movable carrier engage oral features encountered within circular region 363, while a second type of cleaning elements 355 on the second movable carrier subsequently engage the same oral features when encountered within circular region 365. Thus, cleaning elements 352 and 355 can synergistically cooperate to engage oral features, such as teeth, in multiple stages, which can provide enhanced cleaning, polishing or other treatments depending upon the type of cleaning elements and their configuration. In the example configuration shown in FIG. 17, bristles 352 can initially clean oral features engaged within the circular region of diameter D, while portions of elastomeric walls 355 within inner region 365 can subsequently polish the same oral features. Elastomeric walls 355 are illustrated in FIGS. 16-20 as discrete, generally disconnected wall units. However, it is understood that elastomeric walls 355 may be connected to one another and may be formed as wall regions of an integrated structure.

As further shown in FIG. 17, second movable carrier 390 includes a mixture of cleaning elements disposed outside of inner region 365. The mixture of cleaning elements includes bristles 357 along with portions of elastomeric walls 355. As such, oral features encountered outside of diameter D are engaged with both cleaning elements primarily directed to dislodging debris and other cleaning functionality (e.g., bristles), as well as cleaning elements that provide polishing functionality (e.g., portions of upstanding walls 355). Other configurations may include carriers having substantially the same size. However, the configuration of FIG. 17 can be beneficial for ensuring oral features encountered by the first carrier are subsequently encountered by the second carrier via the larger size of secondary carrier 390.

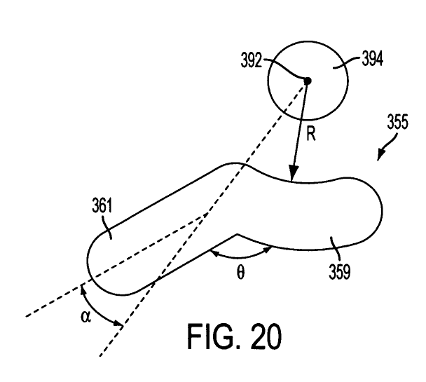

FIG. 20 is a close-up view of one of cleaning elements 355. As shown, an inner portion 359 of the cleaning element is curved to match the direction of rotation of second movable carrier 390. In the configuration shown in FIG. 17, a plurality of these cleaning elements 355 can cooperate to form an interrupted ring of upstanding elastomeric wall portions at a radius R, which, in effect, provides a polishing disk for polishing the user's teeth. The interruptions formed by gaps between the cleaning elements can permit the wall portions to flex toward each other when pressed against the user's teeth. In addition, the interruptions can enhance the cleaning and polishing effectiveness of the upstanding walls via the edge portions and corners of the upstanding wall portions within radius R, which provide geometric features that can interfere with and engage debris or irregular tooth features better than a continuous polishing disk.

An exterior portion 361 of each cleaning element 355 is generally linear and extends radially outward from the pivot point 392 beyond the inner region of radius D. The exterior portion is angled from the inner portion 359 at an acute angle theta of about 30 degrees to about 150 degrees, and is preferably angled about 60 degrees to about 120 degrees. More preferably, angle theta is about 90 to 120 degrees. Such a bent configuration of cleaning elements 355 enhances the overall structural strength of the cleaning elements and improves their ability to remain in the upstanding configuration during use, while increasing their useful life. Exterior portion 361 generally extends in a radial direction from pivot point 392. However, it may be desirable for the exterior portion to be angled slightly from a radial orientation. Thus, as shown in FIG. 20, exterior portion 361 is oriented to have an angle alpha between its longitudinal axis and the radial direction extending from pivot point 392. Angle alpha may be about 45 degrees to about 135 degrees, which provides upstanding wall elements that move generally transversely to the rotation of second movable carrier 390 to provide wiping and polishing functionality. Preferably, however, angle alpha is about 60 to 120 degrees.

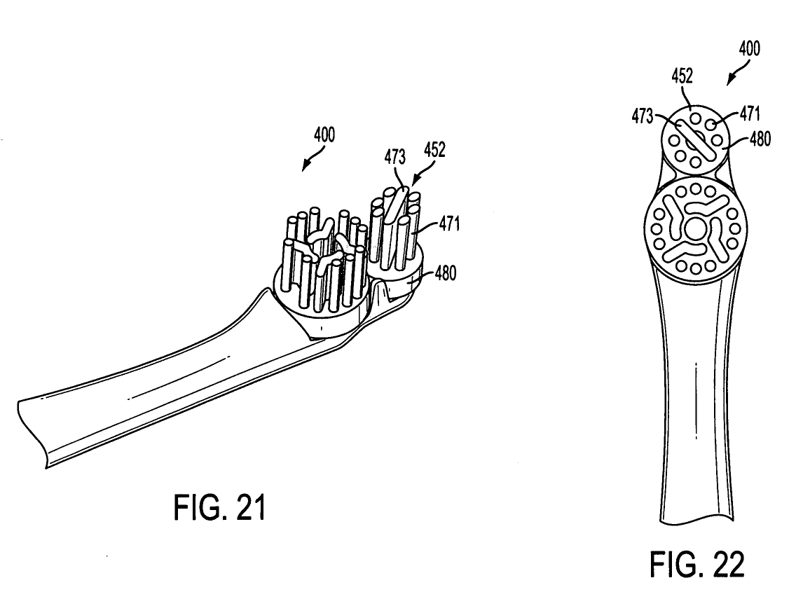

Referring now to FIGS. 21 and 22, a toothbrush head 400 is shown according to an embodiment of the invention that can be used with handle 102 and neck 106 of toothbrush 100. Toothbrush head 400 generally includes the aspects and features and toothbrush 300, except with regard to the cleaning elements on the first movable carrier. As shown, first movable carrier 480 includes cleaning elements 452 formed of bristles 471 and an upstanding elastomeric wall 473. The combination of cleaning element types can further enhance the effectiveness of first movable carrier 480, as well as the overall effectiveness of toothbrush 400. The combination of cleaning element types can provide a synergistic effect to enhance their individual effects. In the configuration shown, bristles 471 can dislodge debris that can subsequently be wiped aside via upstanding elastomeric wall 473. In addition, upstanding elastomeric wall 473 can provide initial polishing functionality to oral features encountered during forward motion of the toothbrush, which can enhance the polishing effectiveness of the cleaning elements 353 of the second movable carrier that subsequently encounter the oral features.

While the present invention has been described in connection with the illustrated embodiments, it will be appreciated and understood that modifications may be made without departing from the true spirit and scope of the invention. In particular, the invention may apply many different oral care devices, configurations and types of cleaning elements and/or methods for using the same.

What is claimed is:

1. A powered oral care device comprising:
a handle portion;
a drive mechanism; and
a head coupled to the handle, the head comprising:
a base;
a first carrier coupled to the base and operatively connected to the drive mechanism for moving the first carrier with respect to the base in a first direction, the first carrier having a plurality of tooth care elements extending outwardly therefrom; and
a second carrier coupled to the base and operatively connected to the drive mechanism for moving the second carrier with respect to the base in a second direction different than the first direction, the second carrier having an upstanding elastomeric wall extending outwardly therefrom.

2. The powered oral care device of claim 1, wherein the upstanding elastomeric wall includes a curved portion.

3. The powered oral care device of claim 2, wherein the second carrier rotates in a rotational direction when driven by the drive member and the upstanding elastomeric wall curved portion is aligned with the rotational direction.

4. The powered oral care device of claim 3, further comprising a plurality of upstanding elastomeric walls on the second carrier, each upstanding elastomeric wall including a curved portion arranged to form an interrupted ring aligned with the rotational direction.

5. The powered oral care device of claim 1, wherein the upstanding elastomeric wall has a serpentine shape.

6. The powered oral care device of claim 1, wherein the second carrier rotates about a pivot point when driven by the drive member and the upstanding elastomeric wall includes a radial portion extending in a generally radial direction from the pivot point.

7. The powered oral care device of claim 1, wherein the first carrier tooth cleaning elements include an upstanding elastomeric wall.

8. The powered oral care device of claim 1, wherein the upstanding elastomeric wall has a bent configuration.

9. A powered oral care device comprising:
a head having a base;
a handle coupled to the head;
a drive mechanism;
a first carrier coupled to the base and operatively connected to the drive mechanism for moving the first carrier with respect to the base in a first direction, the first carrier having a plurality of tooth care elements extending outwardly therefrom;
a second carrier coupled to the base and operatively connected to the drive mechanism for moving the second carrier with respect to the base in a second direction different than the first direction; and
a plurality of upstanding elastomeric wall regions extending outwardly from the second carrier, each wall region having a linear component and a curved component.

10. The powered oral care device of claim 9, wherein the curved component is aligned along a diameter of the second carrier.

11. The powered oral care device of claim 10, wherein the linear component is radially directed away from the curved component.

12. The powered oral care device of claim 9, wherein the plurality of tooth care elements of the first carrier are arranged within a defined region having a circumferential dimension that encompasses the curved components of the wall regions on the second carrier.

13. The powered oral care device of claim 12, wherein the linear components of the walls have free ends that extend beyond the circumferential dimension.

14. A powered oral care device comprising:
a head having a base;
a handle coupled to the head;
a drive mechanism;
a first carrier coupled to the base and operatively connected to the drive mechanism for moving the first carrier with respect to the base in a first direction, the first carrier having a plurality of first tooth care elements extending outwardly therefrom and arranged within a first region having a first diameter; and
a second carrier coupled to the base and operatively connected to the drive mechanism for moving the second carrier with respect to the base in a second direction different than the first direction, the second carrier having a plurality of second tooth care elements extending outwardly therefrom and arranged within a second region having a second diameter;
wherein at least one of said first and second tooth care elements includes an upstanding elastomeric wall.

15. The powered oral care device of claim 14, wherein the first and second diameters are equal and the first and second tooth care elements are of different types.

16. The powered oral care device of claim 15, wherein the first tooth care elements include bristles and the second tooth care elements include upstanding elastomeric wall regions.

17. The powered oral care device of claim 16, wherein the second carrier further comprises a plurality of third tooth care elements arranged outside of the second region.

18. The powered oral care device of claim 17, wherein the plurality of third tooth care elements include bristles.

19. The powered oral care device of claim 16, wherein the second tooth care elements include curved elastomeric wall regions and the plurality of third tooth care elements further include linear elastomeric wall regions connected to the second tooth care elements.

20. The powered oral care device of claim 14, wherein the first tooth care elements include an elastomeric wall.
